(19) United States
(12) Patent Application Publication
(10) Pub. No.: US 2018/0350361 A1
(43) Pub. Date: Dec. 6, 2018

(54) VOICE-MONITORING SYSTEM AND METHOD

(71) Applicant: HONGFUJIN PRECISION ELECTRONICS (TIANJIN) CO.,LTD., Tianjin (CN)

(72) Inventors: SHAO-WEN WANG, New Taipei (TW); SHIH-CHENG WANG, New Taipei (TW)

(21) Appl. No.: 15/641,274

(22) Filed: Jul. 4, 2017

(30) Foreign Application Priority Data
Jun. 2, 2017 (CN) 201710408551.5

(51) Int. Cl. G10L 15/22; G10L 17/22; G10L 17/06; G06F 17/30; G06F 21/32

(52) U.S. Cl. CPC G10L 15/22; G10L 17/22; G10L 2015/223; G06F 17/30743; G06F 21/32; G10L 17/06

(57) ABSTRACT

A voice-monitoring system includes a monitoring center, at least one monitoring device, and a control module. The monitoring center is configured to respond to voice instructions. The control module is configured to receive the voice instructions from staff in monitoring center, convert the voice instructions to voice letters, and determine whether the voice instructions are legal. When the voice instructions are determined to be legal in terms of a recognized task and in terms of the authority of a voiceprint-recognized monitoring staff member, the control module controls the monitoring center to execute operations according to the control instructions, thus the voice-monitoring system can provide control of emergency operations when emergency happens. A voice-monitoring method is also provided.

### FIELD

The subject matter herein generally relates to a monitoring system and a method for monitoring an area.

### BACKGROUND

Electronic monitoring devices can be placed in an area to collect environmental information from the monitored area. The collected environmental information can be temperature, humidity, movement, and security status of the area. A monitoring system and a monitoring method are used for monitoring the area to determine whether an abnormal state exists in the monitored area.

### BRIEF DESCRIPTION OF THE DRAWINGS

Implementations of the present technology will now be described, by way of example only, with reference to the attached figures.

FIG. 1 is a block diagram of one embodiment of a voice-monitoring system.

FIG. 2 illustrates two tables relevant to one embodiment of the voice-monitoring system of FIG. 1.

FIG. 3 is a flowchart of one embodiment of a voice-monitoring method.

FIG. 4 is a flowchart of one embodiment of a block 104 of the voice-monitoring method of FIG. 3.

FIG. 5 is a flowchart of a first embodiment of the voice-monitoring method of FIG. 3.

FIG. 6 is a flowchart of a second embodiment of the voice-monitoring method of FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

The present disclosure is described in relation to a monitoring system for monitoring an area to determine whether an abnormal state (such as a fire disaster) exists in the area.

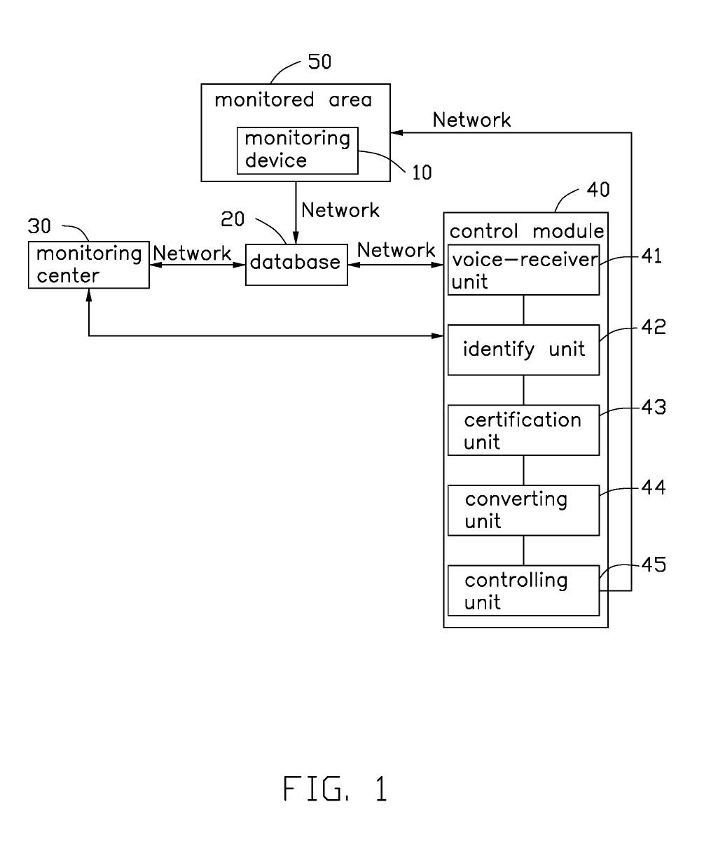

FIG. 1 illustrates an exemplary embodiment of a voice-monitoring system. The voice-monitoring system comprises at least one monitoring device 10, a database 20, a monitoring center 30, and a control module 40. The monitoring center 30 is configured to monitor an area being monitored (monitored area 50). The at least one monitoring device 10 is mounted within the monitored area 50. In at least one exemplary embodiment, the monitored area 50 can be an industrial or factory building, or a public or office building.

In at least one embodiment, monitoring device 10 can be a fire fighting equipment, an environmental monitoring equipment, a safety equipment, or a combination of the above equipments.

The at least one monitoring device 10 is coupled to the database 20 through network. The monitoring center 30 is connected to the database 20 through the network. The at least one monitoring device 10 is coupled to the control module 40 through the network. The control module 40 is coupled to the database 20 through the network.

The at least one monitoring device 10 is configured to collect environmental information from the monitored area 50 through the network.

In at least one exemplary embodiment, the collected environmental information can be temperature, humidity, movement within the monitored area 50, and security status. The database 20 stores the collected environmental information from the at least one monitoring device 10. The database 20 further stores a state of each monitoring device 10. For example, an operation state of the monitoring device 10, a starting state of the monitoring device 10, an on-state, or an off-state.

The monitoring center 30 is configured to obtain the collected environmental information from the database 20. The monitoring center 30 monitors the monitored area 50 according to the obtained environmental information. The monitoring center 30 is configured to determine whether an abnormal state exists in the monitored area 50. When an abnormal state exists in the monitored area 50, the monitoring center 30 can send voice instructions and provide emergency commands for the monitored area 50. The monitoring center 30 comprises at least one monitoring staff member and a monitoring platform. Each monitoring staff member has an identity. A monitoring staff member's identity can be a senior commander or a general commander.

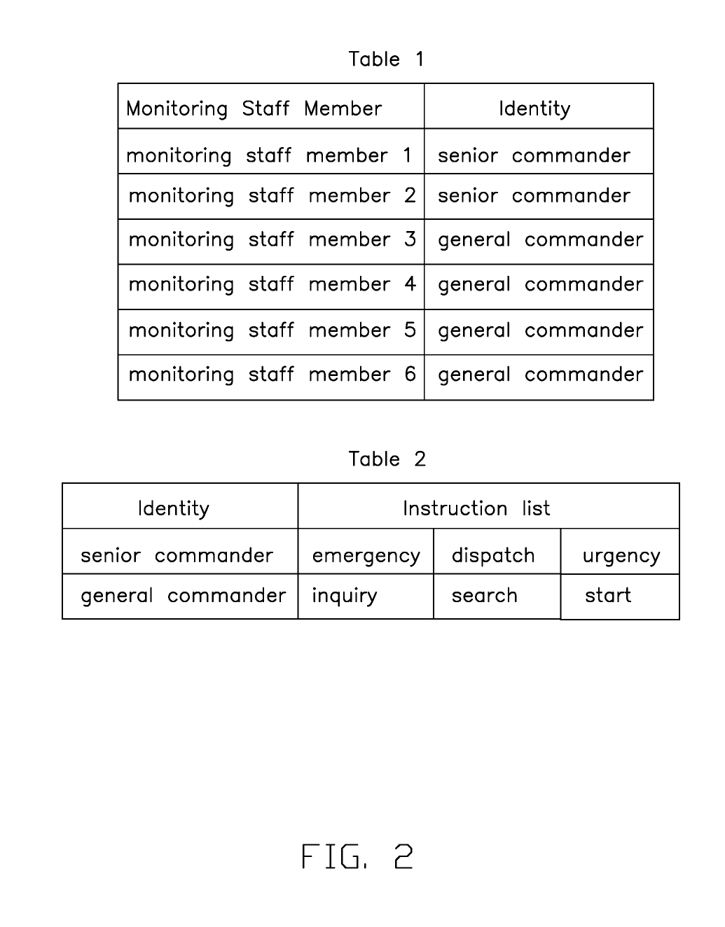

In at least one embodiment, FIG. 2 illustrates two tables, a table 1 and a table 2. The table 1 is an information table. The information table is stored in the database 20. A plurality of monitoring staff members and a plurality of identities are stored in the information table. Each monitoring staff member corresponds to one identity. For example, an identity of a monitoring staff member 1 is a senior commander and an identity of a monitoring staff member 3 is a general commander.

The table 2 is a comparison table. The comparison table is stored in the database 20. A plurality of monitoring staff member identities and an instruction list are stored in the comparison table. The instruction list comprises a plurality of instructions which corresponds to the identity of the monitoring staff member. For example, if an identity of the monitoring staff member is a senior commander, the monitoring staff member corresponds to the instructions “emergency”, “dispatch”, and “urgency.” If an identity of the monitoring staff member is a general commander, the monitoring staff member corresponds to the instructions “inquiry”, “search”, and “start”.

Each monitoring staff member can execute operations through the monitoring platform. For example, each monitoring staff member can start a fire safety inquiry platform, a monitoring staff member, who is a senior commander, can start an emergency command platform, each monitoring staff member can search for people through the monitoring platform, and a monitoring staff member who is a senior commander can dispatch tasks. The monitoring platform is configured to display a plurality of display interfaces when one of the monitoring staff members executes operations.

The display interface displays the voice instructions and an executing state. For example, the executing state can be “Processing” or “Finish”. The display interface displays “instructions: start fire safety inquiry platform”, and displays “executing state: Finish”.

In at least one exemplary embodiment, the control module 40 can be a server.

The control module 40 comprises a voice-receiver unit 41, an identify unit 42, a certification unit 43, a converting unit 44, and a controlling unit 45. The voice-receiver unit 41 is coupled to the identify unit 42. The identify unit 42 is coupled to the certification unit 43. The certification unit 43 is coupled to the converting unit 44. The converting unit 44 is coupled to the controlling unit 45.

The voice-receiver unit 41 is configured to receive the voice instructions from the monitoring staff member, and convert the received voice instructions to voice letters. For example, when the monitoring staff member 1 sends the voice instructions “Now, please execute the fire safety inquiry platform”, the voice-receiver unit 41 receives the voice instructions “Now, please execute the fire safety inquiry platform.” Within the voice instructions, the word “execute” can be converted to voice letters “start”, and the words “execute the fire safety inquiry platform” of the voice instructions can be converted to voice letters “fire safety inquiry platform”.

The identify unit 42 is configured to analyze the voice letters and combine the voice letters into execution instructions. For example, after the identify unit 42 analyzes the voice letters “start” and “fire safety inquiry platform”, the voice letters “start” and “fire safety inquiry platform” are combined into voice letters “start fire safety inquiry platform”. The identify unit 42 is further configured to determine whether the voice instructions are legal in the senses that the voice instructions relate to a task which is recognized and that the particular member of monitoring staff who gives the instruction is authorized to issue such an instruction. For example, the identify unit 42 can determine that the voice letters “start fire safety inquiry platform” (apparently corresponding to the voice instructions “Now, please execute the fire safety inquiry platform”) are legal.

When the identify unit 42 determines the voice instructions are legal in terms of a recognized task, the certification unit 43 is configured to determine an identity of the monitoring staff member issuing the voice instructions, through doing voiceprint recognition. For example, the certification unit 43 determines an identify of the monitoring staff member 1 who issues the voice instructions “Now, please execute the fire safety inquiry platform” to be a senior commander, through performing voiceprint recognition. The certification unit 43 is further configured to determine whether the voice instructions are authorized according to an identity of the monitoring staff member who is issuing the voice instructions and according to the execution instructions corresponding to the voice instructions. For example, the certification unit 43 determines the voice instructions “Now, please execute the fire safety inquiry platform” as being authorized, according to a senior commander identity of the monitoring staff member 1 who is sending such voice instructions.

After the certification unit 43 determines the voice instructions to be authorized, the converting unit 44 converts the authorized instructions to control instructions. The controlling unit 45 is configured to control the monitoring platform to execute operations according to the control instructions. In this example, the controlling unit 45 controls the monitoring platform to start the fire safety inquiry platform.

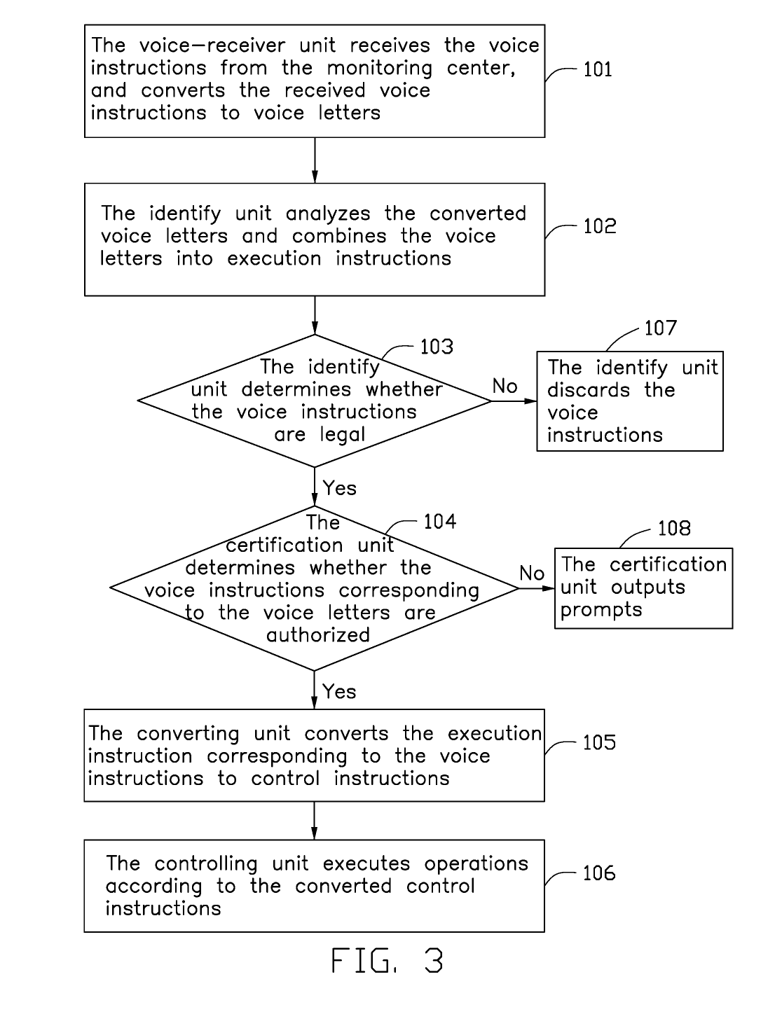

FIG. 3 illustrates a flowchart of a method in accordance with an example embodiment. A voice-monitoring method is provided by way of example, as there are a variety of ways to carry out the method. The method described below can be carried out using the configurations illustrated in FIGS. 1-2, for example, and various elements of these figures are referenced in explaining the voice-monitoring method. The illustrated order of blocks is by example only and the order of the blocks can change. Additional blocks may be added or fewer blocks may be utilized without departing from this disclosure. The voice-monitoring method can begin at block 101.

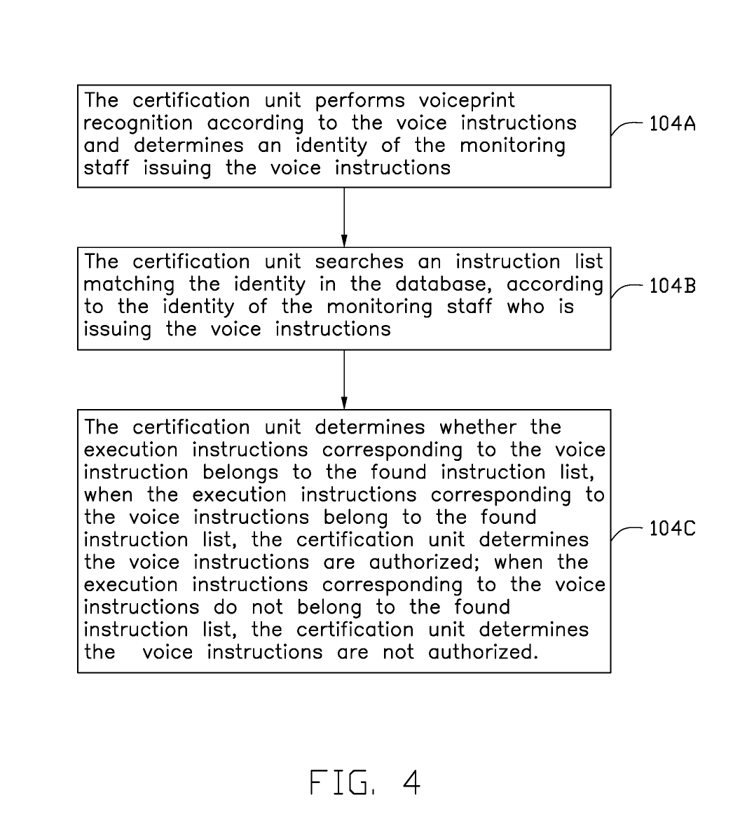

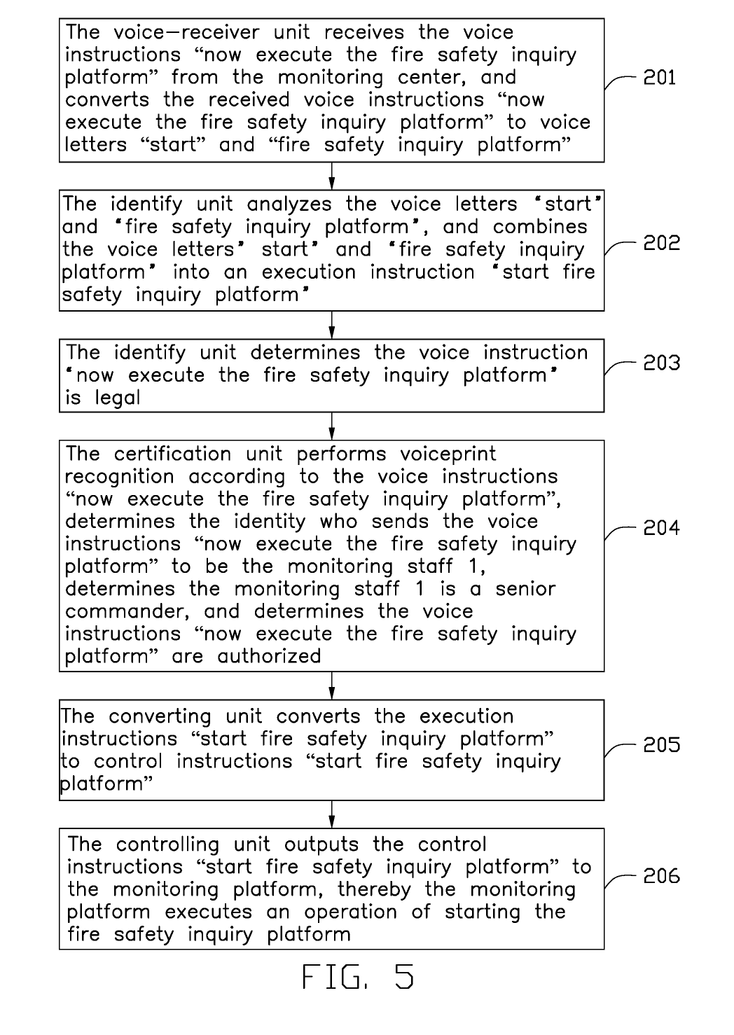

At block 101, the voice-receiver unit 41 receives the voice instructions from the monitoring center 30, and converts the received voice instructions to voice letters. Specifically, the monitoring center 30 obtains the collected environmental information and a state of each monitoring device 10 from the database 20. For example, when the monitoring device 10 generates warning messages after receiving alarm information. The warning messages are stored in the database 20. The monitoring staff member of the monitoring center 30 sends voice instructions after obtaining the warning messages. FIGS. 4-5 illustrate a detailed flowchart.

At block 102, the identify unit 42 analyzes the converted voice letters, and combines the voice letters into execution instructions. For example, the identify unit 42 analyzes the voice letters “start” and “fire safety inquiry platform”, and the voice letters “start” and the voice letters “fire safety inquiry platform” are combined into an execution instruction “start fire safety inquiry platform”.

At block 103, the identify unit 42 determines whether the voice instructions are legal. If yes, the method goes to block 104; if no, the method goes to block 107. For example, the identify unit 42 determines the voice instruction “Now, please execute the fire safety inquiry platform” is legal.

At block 104, the certification unit 43 determines whether the voice instructions corresponding to the voice letters are authorized. If yes, the method goes to block 105; if no, the method goes to block 108. FIG. 4 illustrates a detailed flowchart of the block 104.

At block 105, the converting unit 44 converts the execution instructions corresponding to the voice instructions to control instructions. For example, the converting unit 44 converts the execution instructions corresponding to the voice instructions to control instructions which can be controlled the monitoring platform to execute operations.

At block 106, the controlling unit 45 executes operations according to the converted control instructions. For example, the controlling unit 45 controls the monitoring platform to start the fire safety inquiry platform.

At block 107, the identify unit 42 discards the voice instructions. For example, the identify unit 42 discards the voice instructions “Now, please execute the fire safety inquiry platform”.

At block 108, the certification unit 43 outputs prompts. For example, the display interface of the monitoring platform displays prompts “Sorry, you are not authorized to send the instructions”.

FIG. 4 illustrates a flowchart of block 104 in accordance with an example embodiment. The block 104 is provided by way of example, as there are a variety of ways to carry out the method. The block 104 described below can be carried out using the configurations illustrated in FIGS. 1-3, for example, and various elements of these figures are referenced in explaining the block 104. The illustrated order of blocks is by example only and the order of the blocks can change. Additional blocks may be added or fewer blocks may be utilized without departing from this disclosure. The block 104 can begin at block 104A.

At block 104A, the certification unit 43 performs voiceprint recognition according to the voice instructions and determines an identity of the monitoring staff member issuing the voice instructions.

At block 104B, the certification unit 43 searches an instruction list matching the identity in the database 20, according to the identity of the monitoring staff member who is issuing the voice instructions.

At block 104C, the certification unit 43 determine whether the execution instructions corresponding to the voice instruction belong to the found instruction list, when the execution instructions corresponding to the voice instructions belong to the found instruction list, the certification unit 43 determines the voice instructions are authorized; when the execution instructions corresponding to the voice instructions do not belong to the found instruction list, the certification unit 43 determines the voice instructions are not authorized.

FIG. 5 illustrates a flowchart of a method in accordance with a first example embodiment. In the first exemplary embodiment, when a senior commander from the monitoring center 30 sends voice instructions “Now, please execute the fire safety inquiry platform”, a voice-monitoring method is provided by way of example, as there are a variety of ways to carry out the method. The method described below can be carried out using the configurations illustrated in FIGS. 1-4, for example, and various elements of these figures are referenced in explaining the voice-monitoring method. The illustrated order of blocks is by example only and the order of the blocks can change. Additional blocks may be added or fewer blocks may be utilized without departing from this disclosure. The voice-monitoring method in accordance with the first example embodiment can begin at block 201.

At block 201, the voice-receiver unit 41 receives the voice instructions “Now, please execute the fire safety inquiry platform” from the monitoring center 30, and converts the received voice instructions “Now, please execute the fire safety inquiry platform” to voice letters “start” and “fire safety inquiry platform”.

At block 202, the identify unit 42 analyzes the voice letters “start” and “fire safety inquiry platform”, and the voice letters “start” and the voice letters “fire safety inquiry platform” are combined into an execution instruction “start fire safety inquiry platform”.

At block 203, the identify unit 42 determines the voice instruction “Now, please execute the fire safety inquiry platform” is legal.

At block 204, the certification unit 43 performs voiceprint recognition according to the voice instructions “Now, please execute the fire safety inquiry platform”, determines the identity who sends the voice instructions “Now, please execute the fire safety inquiry platform” to be the monitoring staff member 1, determines the monitoring staff member 1 is a senior commander, and determines the voice instruction “Now, please execute the fire safety inquiry platform” is authorized.

At block 205, the converting unit 44 converts the execution instructions “start fire safety inquiry platform” to control instructions “start fire safety inquiry platform”.

At block 206, the controlling unit 45 outputs the control instructions “start fire safety inquiry platform” to the monitoring platform, thereby the monitoring platform executes an operation of starting the fire safety inquiry platform.

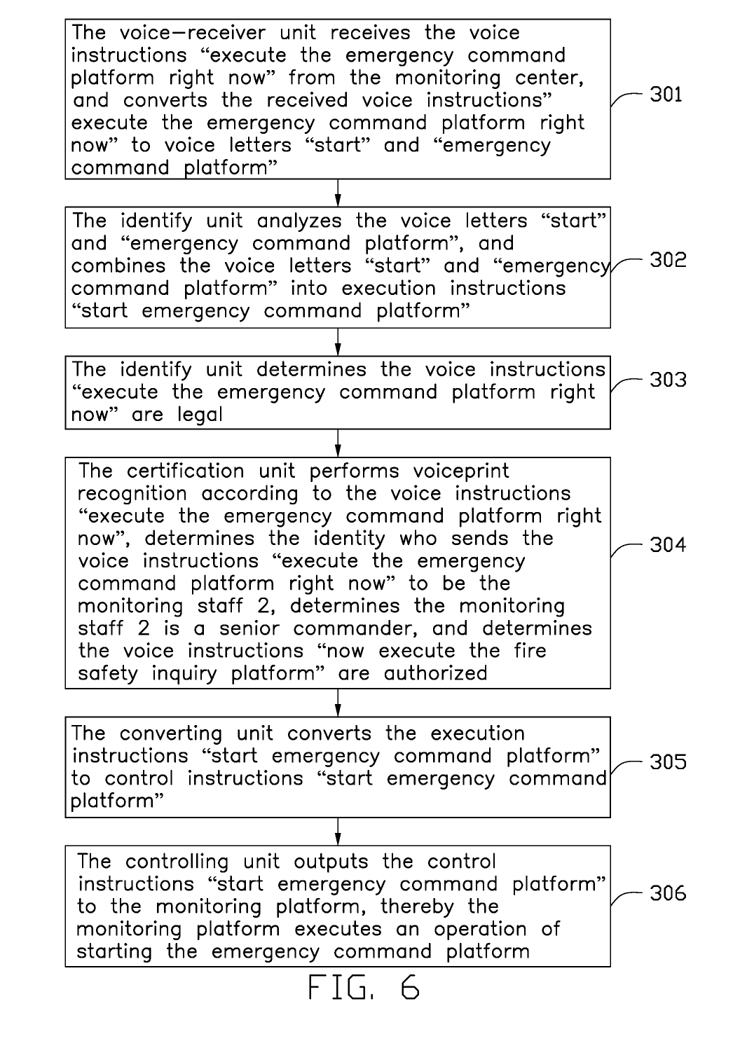

FIG. 6 illustrates a flowchart of a method in accordance with a second example embodiment. In the second exemplary embodiment, when an alarm happens (such as fire disaster), the monitoring device 10 generates warning messages after receiving alarm information and the warning messages are stored in the database 20, the monitoring center 30 obtains the warning messages from the database 20, the monitoring platform automatically switches to a fire notification acceptance display interface, then the monitoring platform automatically switches to an emergency organization display interface, displays emergency strain flow, and displays an emergency command window. The monitoring staff member from the monitoring center 30 determines fire disaster exists, the monitoring staff member, whose identity being a senior commander, sends voice instructions “execute the emergency command platform right now”.

In the second exemplary embodiment, a voice-monitoring method is provided by way of example, as there are a variety of ways to carry out the method. The method described below can be carried out using the configurations illustrated in FIGS. 1-4, for example, and various elements of these figures are referenced in explaining the voice-monitoring method. The illustrated order of blocks is by example only and the order of the blocks can change. Additional blocks may be added or fewer blocks may be utilized without departing from this disclosure. The voice-monitoring method in accordance with the second example embodiment can begin at block 301.

At block 301, the voice-receiver unit 41 receives the voice instructions “execute the emergency command platform right now” from the monitoring center 30, and converts the received voice instructions “execute the emergency command platform right now” to voice letters “start” and “emergency command platform”.

At block 302, the identify unit 42 analyzes the voice letters “start” and “emergency command platform”, and the voice letters “start” and “emergency command platform” are combined into execution instructions “start emergency command platform”.

At block 303, the identify unit 42 determines the voice instructions “execute the emergency command platform right now” are legal.

At block 304, the certification unit 43 performs voiceprint recognition according to the voice instructions “execute the emergency command platform right now”, determines the identity who sends the voice instructions “execute the emergency command platform right now” to be the monitoring staff member 2, determines the monitoring staff member 2 is a senior commander, and determines the voice instructions “now execute the fire safety inquiry platform” are authorized.

At block 305, the converting unit 44 converts the execution instructions “start emergency command platform” to control instructions “start emergency command platform”.

At block 306, the controlling unit 45 outputs the control instructions “start emergency command platform” to the monitoring platform, thereby the monitoring platform executes an operation of starting the emergency command platform.

In a third exemplary embodiment, when the monitoring staff member needs search for positions of the spot commanders, the monitoring staff member sends voice instruction “search for positions of the spot commanders”, the control module 40 controls the monitoring platform to switch a positions display interface after receiving the voice instructions “search for positions of the spot commanders”, the display interface displays map information and the positions of the spot commanders on the map, then the monitoring staff member can send corresponding voice instructions according to practical requirements.

In a fourth exemplary embodiment, when the monitoring staff member needs dispatch tasks to the spot commanders, the monitoring staff member sends voice instruction “dispatch tasks to the spot commanders”, the control module 40 controls the monitoring platform to switch a display interface which has an emergency processing organization chart, after receiving the “dispatch tasks to the spot commanders”, and popup a commanding strained support decision window, thus the monitoring staff member can select a plurality of implementation items, such as person rescue, ventilation and smoke discharge, fire extinction action, and so on.

In the voice-monitoring system and the voice-monitoring method, the monitoring center 30 can obtain the corresponding environmental information and states of the at least one monitoring device 10 from the monitoring device 10, thus the monitoring staff member sends corresponding voice instructions according to practical requirements, the control module 40 controls the monitoring platform to do operations according to the voice instructions, thus, when emergency situation exists, emergency commands can be supported.

The exemplary embodiments shown and described above are only examples. Many details are often found in the art such as the other features of a voice-monitoring system and a voice-monitoring method. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A voice-monitoring system comprising:
a control module comprising:
a certification unit;
an identify unit coupled to the certification unit;
a voice-receiver unit coupled to the identify unit;
a converting unit coupled to the certification unit; and
a controlling unit coupled to the converting unit;
at least one monitoring device coupled to the control module through a network; and
a monitoring center coupled to the control module through the network, mounted in a monitoring area, and configured to send voice instructions;
wherein the voice-receiver unit is configured to:
receive the voice instructions from the monitoring center; and
convert the received voice instructions to voice letters;
wherein the identify unit is configured to determine whether the voice instructions are legal according to the voice letters;
wherein the certification unit is configured to:
perform voiceprint recognitions according to the voice instructions to determine an identity of a member of a monitoring staff sending the voice instructions when the identify unit determines the voice instructions are legal; and
determine whether the voice instructions to be authorized according to the voice letters and according to the identity of the member of the monitoring staff sending the voice instructions;
wherein the converting unit is configured to convert the voice letters to control instructions when the certification unit determines the voice instructions to be authorized;
wherein the controlling unit is configured to control the monitoring center to execute operations according to the control instructions.

2. The voice-monitoring system of claim 1, further comprising a database, wherein the monitoring device is coupled to the database through the network, the monitoring center is coupled to the database through the network, the control module is coupled to the database through the network, the monitoring device is configured to collect environmental information of the monitored area, the database stores states of the at least one monitoring device, and the database further stores the collected information from monitoring device.

3. The voice-monitoring system of claim 2, wherein the database further stores an information table, the information table corresponds to an identity of each member of the monitoring staff.

4. The voice-monitoring system of claim 3, wherein the database further stores a comparison table, the comparison table comprises the identity of each member of the monitoring staff and an instruction list corresponding to the identity of each member of the monitoring staff.

5. The voice-monitoring system of claim 4, the identify unit is further configured to analyze the voice letters and combine the voice letters into execution instructions.

6. The voice-monitoring system of claim 4, wherein certification unit is configured to:
perform voiceprint recognitions according to the voice instructions;
determine the identity of the member of the monitoring staff sending the voice instructions;
search an instruction list matching the identity of the member of the monitoring staff according to the voice instructions.

7. The voice-monitoring system of claim 6, wherein certification unit is configured to:
determine the voice instructions to be authorized when the execution instruction corresponding to the voice instructions belong to the found instruction list; and
determine the voice instructions not to be authorized when the execution instruction corresponding to the voice instructions do not belong to the found instruction list.

8. The voice-monitoring system of claim 6, wherein the instruction list comprises a plurality of instructions which corresponding to the identity of each member of the monitoring staff.

9. The voice-monitoring system of claim 8, wherein the identity of each member of the monitoring staff can be a senior commander or a general commander, when the identity is a senior commander, the instructions corresponding to senior commander comprise “emergency”, “dispatch”, and “urgency”.

10. The voice-monitoring system of claim 8, wherein the identify unit is configured to discard the voice instructions when determining the voice letters not to be legal.

11. A voice-monitoring method used in a voice-monitoring system, the voice-monitoring system comprises a monitoring center, at least one monitoring device, and a control module, the monitoring device is mounted in the monitored area, the control module comprises a voice-receiver unit, an identify unit, a certification unit, a converting unit, and a controlling unit, the monitoring center is configured to send voice instructions, and the voice-monitoring method comprising:
receiving the voice instructions from the monitoring center;
converting the received voice instructions to voice letters;
performing voiceprint recognitions according to the voice instructions to determine an identity of a member of a monitoring staff sending the voice instructions when the identify unit determining the voice instructions are legal;
determining whether the voice instructions to be authorized according to the voice letters and according to the identity of the member of the monitoring staff sending the voice instructions;
converting the voice letters to control instructions when the certification unit determining the voice instructions to be authorized; and
controlling the monitoring center to execute operations according to the control instructions.

12. The voice-monitoring method of claim 11, further comprising:
analyzing the voice letters; and
combining the voice letters into execution instructions.

13. The voice-monitoring method of claim 12, wherein the step of “determining whether the voice instructions to be authorized according to the voice letters and according to the identity of the member of the monitoring staff sending the voice instructions” comprising:
performing voiceprint recognitions according to the voice instructions; and
determining the identity of the member of the monitoring staff sending the voice instructions when the identify unit determining the voice instructions are legal.

14. The voice-monitoring method of claim 13, wherein the step of “determining whether the voice instructions to be authorized according to the voice letters and according to the identity of the member of the monitoring staff sending the voice instructions” further comprising a step of searching an instruction list matching the identity of the member of the monitoring staff according to the voice instructions.

15. The voice-monitoring method of claim 14, wherein the step of “determining whether the voice instructions to be authorized according to the voice letters and according to the identity of the member of the monitoring staff sending the voice instructions” further comprising:
determining the voice instructions to be authorized when the execution instruction corresponding to the voice instructions belong to the found instruction list; and
determining the voice instructions not to be authorized when the execution instruction corresponding to the voice instructions do not belong to the found instruction list.

16. The voice-monitoring method of claim 14, wherein the identity can be a senior commander or a general commander.

17. The voice-monitoring method of claim 16, wherein the instruction list comprises a plurality of instructions which corresponding to the identity of the member of the monitoring staff, when the identity is a senior commander, the instructions corresponding to senior commander comprise “emergency”, “dispatch”, and “urgency”.

18. The voice-monitoring method of claim 17, wherein a plurality of monitoring staff members and the instruction list are stored in a comparison table, the comparison table is stored in a database.

19. The voice-monitoring method of claim 11, further comprising a step of discarding the voice instructions when the voice letters are not legal.

20. The voice-monitoring method of claim 19, further comprising a step of outputting prompts after the step of discarding the voice instructions.
